(19) United States
(12) Patent Application Publication
(10) Pub. No.: US 2013/0279354 A1
(43) Pub. Date: Oct. 24, 2013

(54) WIRELESS NETWORK PERFORMANCE ANALYSIS SYSTEM

(71) Applicant: MOBILE PULSE, INC., Denver, CO (US)

(72) Inventors: Christine Ekman, Denver, CO (US); James C. Fouch, Denver, CO (US); Edward D. Sullivan, Carlisle, MA (US); Andrew G. MacFarlane, Denver, CO (US); Kevin B. Capp, Castle Rock, CO (US)

(73) Assignee: MOBILE PULSE, INC., Denver, CO (US)

(21) Appl. No.: 13/860,668

(22) Filed: Apr. 11, 2013

Related U.S. Application Data
(60) Provisional application No. 61/625,879, filed on Apr. 18, 2012.

(51) Int. Cl. H04W 24/00

(52) U.S. Cl. CPC H04W 24/00
USPC 370/252

(57) ABSTRACT

The Mobile Pulse System makes use of a client application which is installed in each mobile device of a customer to obtain dynamic measurements of the service that is provided to the mobile device by a wireless service provider. These client applications perform frequent tests to determine the level of service that they are presently receiving, which test results are transmitted to the Mobile Pulse System server for compilation and analysis. As a result of the number and diversity of these tests, the server can accurately map the level of service that is being provided by the wireless service provider to a customer. The server can portray the level of service as a function of the type of mobile device used by the customer, specific locations within the service area, time of day, type of communications, and other such relevant parameters.

### FIELD OF THE INVENTION

This invention relates to wireless networks and, in particular, to a system for assessing the dynamic performance characteristics of the wireless network for a particular customer.

### BACKGROUND OF THE INVENTION

It is a problem in the field of wireless networks to determine the level of communication service that mobile devices are receiving from a wireless service provider. The wireless networks include cellular networks as well as WiFi networks (collectively termed “wireless networks” herein), which provide mobile devices with access to the Internet as well as to private networks. This is particularly significant for corporate and governmental customers (collectively termed “customer” herein) who have numerous mobile devices that are served by the wireless network. The customer may have numerous types of mobile devices that are operational in a particular service area; and as they roam through the service area of the wireless and/or WiFi service provider, the level of service varies. Presently, however, there is no system that enables quantification of this variation in the level of service provided. In addition, the customer also may be any group of users such as a group of individuals having a community of interest, or a family, where the individuals are united under a single customer billing account.

In the arena of wireless network performance testing, a cellular service provider typically performs tests of the cellular network to ensure its operational status, but these tests are both infrequent and lacking in specific mobile device-centric testing to enable the wireless service provider to obtain an accurate and in-depth view of the actual level of service that is being provided to the mobile devices extant in the wireless network and, more particularly, the level of service being provided to the mobile devices of any particular customer. Similarly, a WiFi network is a fixed base operation that serves a geographically limited and defined area, with testing of the level of service provided being infrequent at best. The WiFi network operator also fails to obtain an accurate and in-depth view of the actual level of service that is being provided to the mobile devices extant in the wireless network and, more particularly, the level of service being provided to the mobile devices of any particular customer. A complicating factor is that any tests that are performed represent an isolated snapshot in time of network performance and a true temporally accurate analysis of the network is not obtained.

Therefore, a customer is unable to accurately determine whether their mobile devices are receiving adequate service and also to be able to quantify the failure of the wireless service provider to supply the level of service for which the customer has subscribed. The service provider also is unable to detect and identify anomalies and transient problems in network performance.

### BRIEF SUMMARY OF THE INVENTION

The present Wireless Network Performance Analysis System (termed “Mobile Pulse System” herein) makes use of a client application which is installed in a customer's mobile devices to obtain dynamic measurements of the service that is provided to the mobile device by a wireless service provider. These client applications perform frequent tests to measure various wireless network characteristics as presented at the mobile device thereby to determine the level of service that they are presently receiving, which test results are transmitted to a server for compilation and analysis. As a result of the number and diversity of these tests, the server can accurately map the level of service that is being provided by the wireless service provider to a customer. The server can portray the level of service as a function of the type of mobile device used by the customer, specific locations within the service area, time of day, type of communications, and other such relevant parameters.

These customer-generated test results provide a dynamic representation of the level of service that is received by the customer's mobile devices and can identify locations in the coverage area of the wireless service provider where communication services fail to satisfy the minimum required by the customer. The customer data typically is maintained in confidence, so the information regarding the location, movement, and type of communications of their mobile devices is not available to others. However, the reported data can be anonymized, with the permission of the customer, to provide an additional level of detail in documenting the performance of the wireless network. It is obvious that numerous reports can be generated and correlations among mobile device characteristics computed to provide various spatial and temporal views of the wireless network.

On a basic level, customers are interested in receiving information which defines with greater clarity and precision wireless service areas that, anecdotally, have poor service performance. The solution implemented by the Mobile Pulse System involves an algorithm applied to a customer's performance results in order to determine a percentage of tests within any given geography that have fallen below a given “poor performance” threshold. The threshold value is computed using the data upload speed and latency as measured by the customer's mobile devices. These metrics are highly correlated with poor performance and, therefore, are suitable predictors of the service that will be provided to the customer's mobile devices when they are located in these areas.

### BRIEF DESCRIPTION OF THE DRAWINGS

FIG. 1 illustrates the present Mobile Pulse System in block diagram form;

FIGS. 2A and 2B illustrate the typical cell site patterns used in cellular networks;

FIGS. 3 and 4 illustrate, in flow diagram form, the operation of the Mobile Pulse system;

FIGS. 5A-5Q illustrate a typical data structure used in the Mobile Pulse System and the typical range of data that is collected by the Mobile Pulse System, respectively;

FIG. 6 illustrates, in flow diagram form, the operation of the Mobile Pulse System to identify areas of network poor performance; and

FIG. 7 illustrates a chart of some typical measurements that illustrate the operation of the Mobile Pulse System.

### DETAILED DESCRIPTION OF THE INVENTION

### Wireless Networks

WiFi is the term used to describe a technology that allows an electronic device to wirelessly exchange data over a computer network. A WiFi network uses one or more wireless access points to connect users to an adjacent wired Local Area Network which provides access to the Internet. Numerous technologies are available to implement the WiFi network, and the 802.11 family of standards typically is used to define the communication protocols. In a multi-access node network, the electronic device can roam from one access point to another when the signal strength at the original access node is determined to be too weak.

A WiFi-enabled device can connect to the Internet when within range of a wireless network. The coverage of one or more (interconnected) access points—called hotspots—can extend from an area as small as a few rooms to as large as many square miles. Coverage in the larger area may require a group of access points with overlapping coverage. Outdoor public WiFi technology has been used successfully in wireless mesh networks. WiFi also provides service in private homes and independent businesses, as well as in public spaces at WiFi hotspots set up either free of charge or commercially. Organizations and businesses, such as airports, hotels, and restaurants, often provide free-use hotspots to attract customers. Enthusiasts or authorities who wish to provide services or even to promote business in selected areas sometimes provide free WiFi access.

Cellular networks provide the service of connecting mobile devices to both mobile devices that are served by the cellular service provider as well as land-based customers served by the public telephone network. In such a system, the mobile device originated traffic is routed through Mobile Telephone Switching Offices (MTSO), each of which is connected to a plurality of cell sites (base station subsystems) which communicate with mobile devices located in the area covered by the cell sites. The mobile devices are served by the cell sites, each of which is located in one cell area of a larger service region. Each cell site in the service region is connected by a group of communication links to the Mobile Telephone Switching Office. Each cell site contains a group of radio transmitters and receivers, with each transmitter-receiver pair being connected to one communication link.

### Cell Configuration

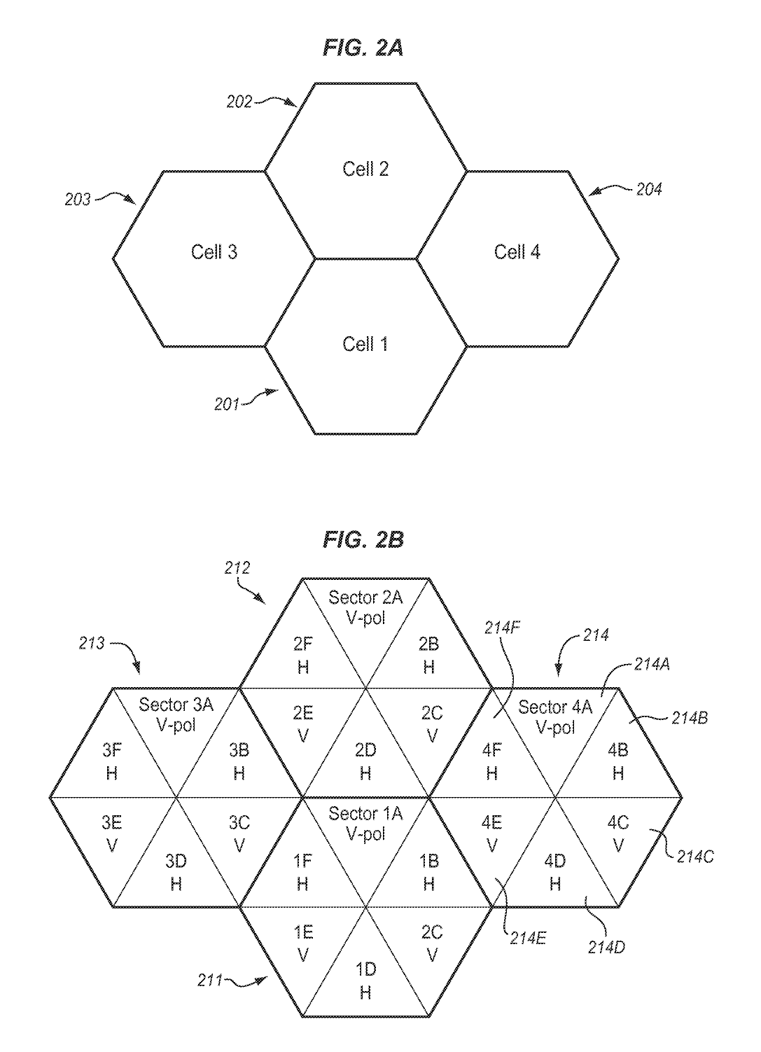

FIGS. 2A and 2B illustrate the typical cell site patterns used in cellular networks. The terms “cell site” and “cell” are sometimes loosely used in the literature; and the term “cell site” 201-204 generally denotes the locus at which the transmitter and receiver apparatus is located, while the term “cell” generally denotes the region of space which is served by a particular transmitter-receiver pair which is installed at a cell site. The particular technology used to implement the communications between mobile devices and the transmitter-receiver pairs, as well as the nature of the data transferred therebetween, be it voice, video, telemetry, computer data, and the like, are not limitations to the Mobile Pulse System 100 which is described herein, since a novel system concept is disclosed, not a specific technologically-limited implementation of an existing system concept. Therefore, the term “cellular” as it is used herein denotes a communication system which operates on the basis of dividing space into a plurality of volumetric sections or cells and managing communications between mobile devices located in the cells and the associated transmitter-receiver pairs located at the cell site for each of these cells.

### Call Connection

As is well known, the first stage of a cellular communication connection is set up when a transmitter-receiver pair in a cell site, operating on a predetermined pair of radio frequencies, is turned on and a mobile device, located in the cell site, is tuned to the same pair of radio frequencies. The second stage of the communication connection is between the communication link connected to this transmitter-receiver pair and the cellular service provider network. This second stage of the communication connection is set up in the Mobile Telephone Switching Office, which is connected to the cellular service provider network by incoming and outgoing trunks. The Mobile Telephone Switching Office contains a switching network to switch mobile device voice and/or data signals from the communication link to an incoming or outgoing trunk. The Mobile Telephone Switching Office controls the actions of the associated cell site controllers by generating and interpreting the control messages that are exchanged with the associated cell site controllers over the data links. The cell site controllers at each cell site, in response to control messages from the Mobile Telephone Switching Office, control the transmitter-receiver pairs at the cell site (or code word assignment in the case of CDMA). The control processes at each cell site also control the tuning of the mobile devices to the selected radio frequencies.

Each cell in the cellular network comprises a predetermined volume of space radially arranged around the cell site transmitting antenna with the region of space typically approximating a cylindrical volume or a portion of a cylindrical volume having limited height. Since all of the mobile devices are installed in ground-based units (such as motor vehicles or handheld units) in traditional cellular networks, the antenna radiation pattern of the cell site is aligned to be proximate to the ground, and the polarization of the signals produced by the cell site antenna is vertical in nature. In order to prevent the radio signals in one cell site from interfering with radio signals in an adjacent cell site, the transmitter frequencies for adjacent cell sites are selected to be different so that there is sufficient frequency separation between adjacent transmitter frequencies to avoid overlapping transmissions among adjacent cell sites, different code words, or timeslots. In order to reuse the same frequencies, the cellular industry has developed a small but finite number of transmitter frequencies and a cell site allocation pattern that ensures that two adjacent cell sites do not operate on the same frequency with four different frequency allocations shown as cells 201-204. When a mobile device initiates a call connection, control signals from the local cell site transmitter cause the frequency agile transponder in the mobile device to operate at the frequency of operation designated for that particular cell site. As the mobile device moves from one cell site to another, the call connection is handed off to the successive cell sites; and the frequency agile transponder in the mobile device adjusts its frequency of operation to correspond to the frequency of operation of the transmitter located in the cell site in which the mobile device is presently operational.

It is a problem in the field of wireless networks to determine the level of service that mobile devices are receiving from a wireless service provider. This is particularly significant for corporate and governmental customers (collectively termed “customer” herein) who have numerous mobile devices that are served by the wireless networks. The customer may have numerous types of mobile devices that are operational in a particular service area; and as they roam through the service area of the wireless service provider, the level of service varies. Presently, however, there is no system that enables quantification of this variation. The customer is unable to accurately determine whether their mobile devices are receiving adequate service and also to be able to quantify the failure of the wireless service provider to supply the level of service for which the customer has subscribed.

### Mobile Pulse System Architecture

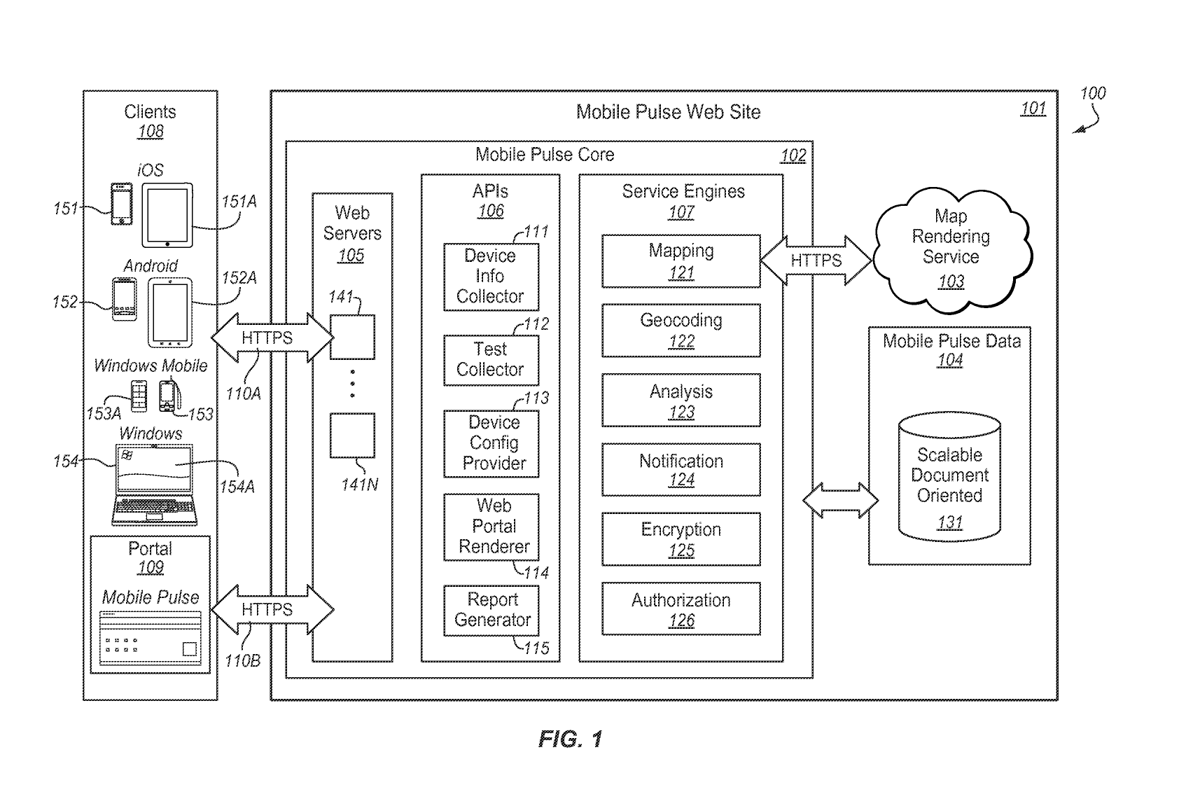

FIG. 1 illustrates the present Mobile Pulse System 100 in block diagram form. The Mobile Pulse System 100 consists of a Mobile Pulse WEB Site 101 communicatively connected via wireless networks 110A, 110B to a plurality of mobile device applications 151A-154A, each of which is installed and operational in a customer mobile device 151-154. The mobile device applications 151A-154A are specific to the type of mobile device and, for illustration purposes, the following presently available mobile devices and their Mobile Pulse reporting applications are shown: IOS 151/151A, Android 152/152A, Windows Mobile 153/153A, and Windows 154/154A. These mobile devices 151-154 are simply illustrative of the range of devices that are served by wireless network 110A/110B, and this illustration is not intended to limit the scope of the description. In addition, this system and its functionality are intended for use with all types of wireless networks, and the present description uses a cellular network as the primary example; but this is not intended to limit the scope of the system as defined in the appended claims.

The mobile devices 151-154 can communicate with the Mobile Pulse WEB site 101 which provides the data collection, processing, analysis, and report generation functionality. The Mobile Pulse WEB site 101 includes a database 104 which stores the collected and generated data, a mapping process 103, which can optionally be located external to the Mobile Pulse WEB Site 101, and which translates the collected and processed data into a map format for report purposes. The Mobile Pulse WEB site 101 also includes various servers 105, application processes 106, and service engines 107 as are described herein. There is a Mobile Pulse WEB site portal 109 which provides customers with access to the Mobile Pulse WEB Site 101 for access to the data collected from the customer mobile devices and to access reports that are generated using the customer data.

The Mobile Pulse WEB site 101 includes a plurality of servers 141-14N which function to communicate with the customer's mobile devices 151-154, to download and install the mobile device applications 151A-154A, to periodically receive data transfers from the mobile devices 151-154, and to update the operational characteristics of the mobile device applications 151A-154A. These servers 141-14N also execute WEB Portal Rendered 114 to host the Mobile Pulse WEB site portal 109 to enable customer access.

The Mobile Pulse WEB site 101 hosts a plurality of applications 106 which execute thereon including, but not limited to: Mobile Device Information Collector 111, Test Data Collector 112, Mobile Device Configurator 113, WEB Portal Renderer 114, and Report Generator 115, as are described below.

### Operation of the Mobile Pulse System

### Initial Activation of a Mobile Device

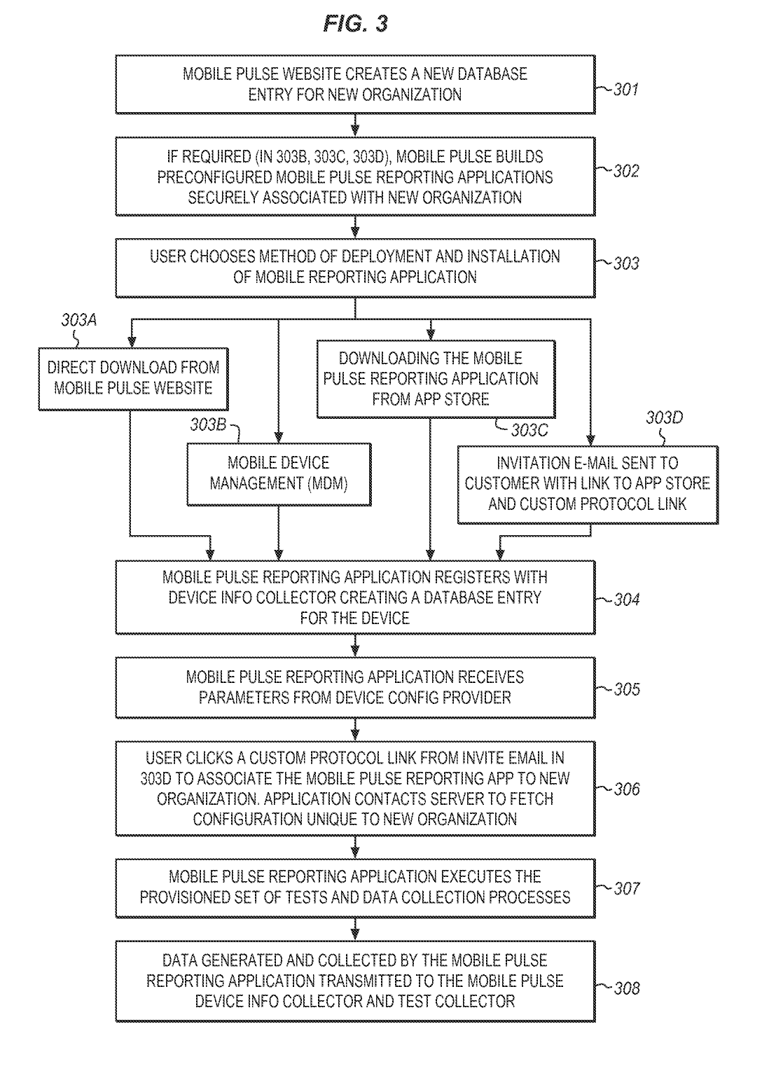

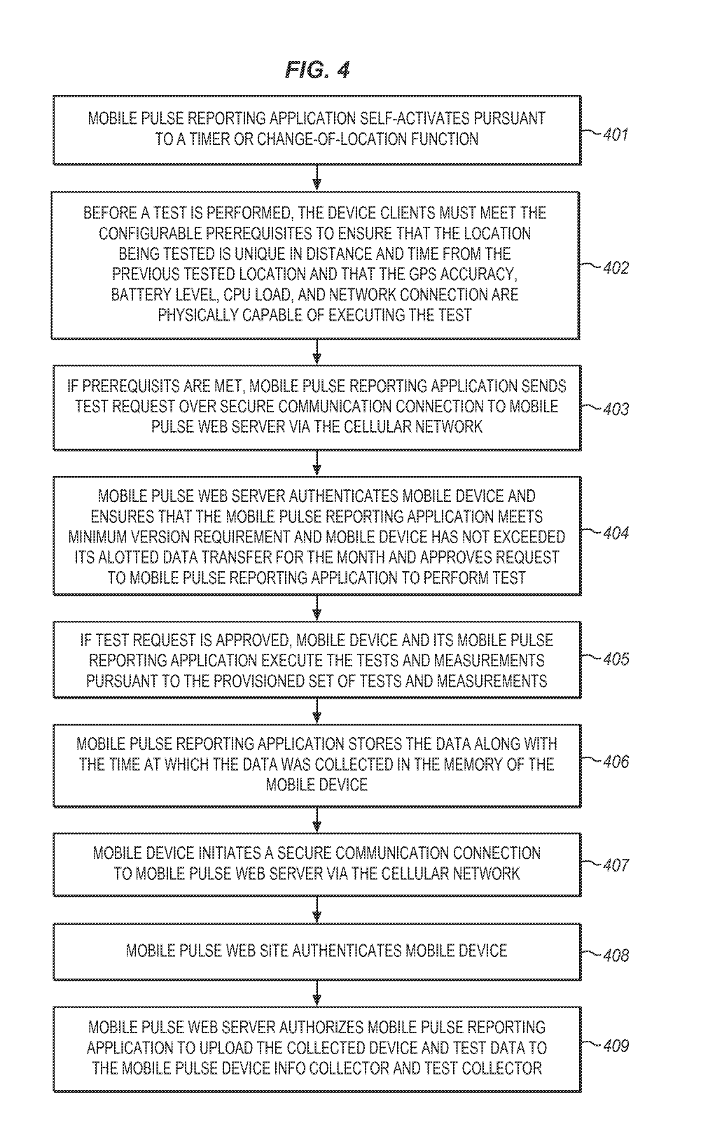

FIGS. 3 and 4 illustrate, in flow diagram form, the operation of the Mobile Pulse System 100. FIG. 3 represents the steps taken by the Mobile Pulse System 100 to register and activate a mobile device (for example, mobile device 151). At step 301, Mobile Pulse WEB Site 101 creates a new database entry in database 104 for a new organization (customer). The Mobile Pulse WEB Site 101, at step 302, builds preconfigured mobile pulse reporting applications (for example, 151A-154A) which are securely associated with the new organization. The user at mobile device 151, at step 303, selects the method that is to be used to deploy and install the Mobile Pulse reporting application 151A on their mobile device 151.

There are four methods to deploy and install the Mobile Pulse reporting application 151A shown as examples in FIG. 3: direct download from a Mobile Pulse website 303A; Mobile Device Management 303B installation of a custom client; Web based apps store purchase of a preconfigured app 303C; and invitation email of a link to a download site 303D. The direct download method of step 303A is a custom client installation that enables the user to access (via the wireless network 110A) the uniquely addressed download site (for example, Mobile Pulse WEB server 141) to retrieve and install a Mobile Pulse reporting application that has been created with preconfigured settings and pre-associated to the customer/organization who owns/manages the mobile device 151. Alternatively, a mobile device management (MDM) installation of a custom client can be used at step 303B. The mobile pulse reporting application is preconfigured to an organization and directly downloaded and installed via MDM to the customer's mobile devices. In addition, the user can select installation from a public “appstore” where, at step 303C, the user can retrieve and install a Mobile Pulse reporting application that has been created with preconfigured settings and pre-associated to the customer/organization who owns/manages the mobile device 151, from a device manufacturer's public app store. Finally, an alternative public app store installation option of step 303D can be used, where an invitation email is sent to the user, with the e-mail containing: (1) a link to an un-configured Mobile Pulse reporting application in a manufacturer's public app store, and (2) a custom protocol link to associate the application to a new organization. The user downloads and installs the selected application on their mobile device. Because step 303D does not require pre-configuration, step 302, therefore, is conditional, followed only when deployed through proposed steps 303A, 303B, or 303C.

The Mobile Pulse reporting application 151A, at step 304, registers with the Device Information Collector process 111 which creates a database entry in database 104 for this mobile device 151. The database entry includes the device identification, the customer with which this mobile device is affiliated, as well as the type of mobile device. At step 305, the Device Configuration Provider process 113 of Mobile Pulse WEB Site 101 sets the parameters of the Mobile Pulse reporting application 151A, which include the wireless network tests and the associated data collection processes that are provisioned on this mobile device, as well as the temporal schedule of tests to be executed by the mobile device. This set of parameters can include predetermined thresholds which are indicative of measured wireless network performance metrics that automatically trigger a revised schedule of tests, such as increasing/decreasing the frequency of the tests or the amount of data collected in executing the tests to control the granularity of the data obtained from this mobile device and/or the processing load on the mobile device. If the user has elected the process of step 303D, at step 306, the user clicks on a custom protocol link from the invitation e-mail received in step 303D to associate the Mobile Pulse reporting application to the new organization. The Mobile Pulse reporting application contacts the Mobile Pulse Server to fetch a configuration that is unique to the new organization.

At step 307, the Mobile Pulse reporting application 151A is enabled to execute the set of tests and data collection processes that are provisioned in the Mobile Pulse reporting application 151A, based on the test schedule that is programmed in the Mobile Pulse reporting application 151A. The data generated and collected by the Mobile Pulse reporting application 151A typically are stored in the memory of the Mobile Pulse reporting application 151A and periodically transmitted, at step 308, to the Mobile Pulse WEB Site 101 for entry into database 104 by Test Collector 112 and processing by applications 106, 107 that are subscribed to by the customer.

For devices that are not pre-associated under step 302, a step is required to associate the device with a customer's organization. After step 306, a user clicks a custom protocol link from the invite email sent in step 303D to associate the Mobile Pulse reporting app to the new organization. The application contacts a server to fetch a configuration unique to the new organization.

### Periodic Data Collection and Reporting

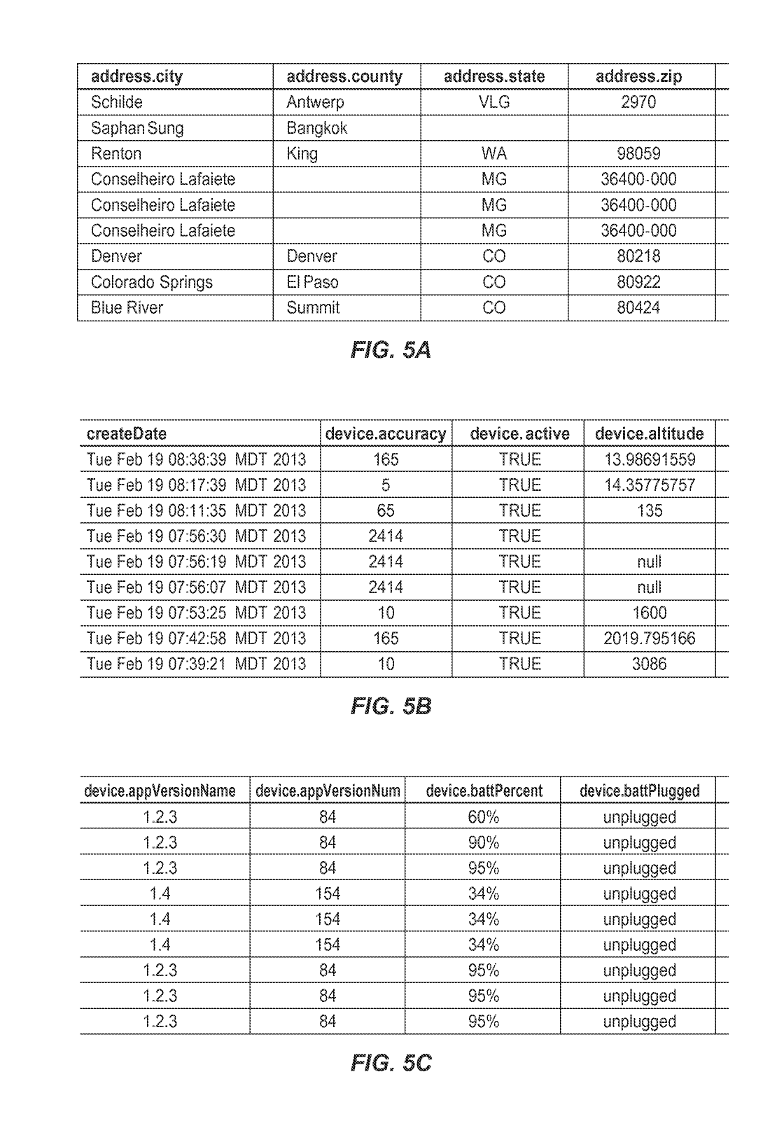

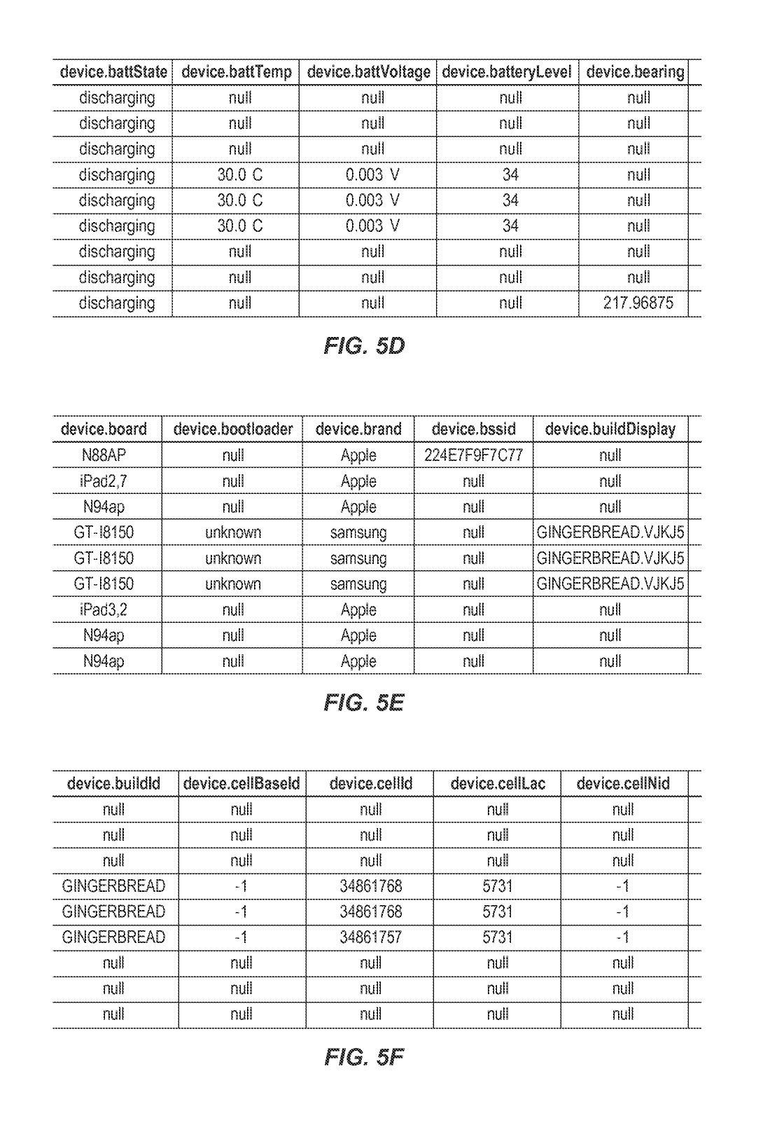

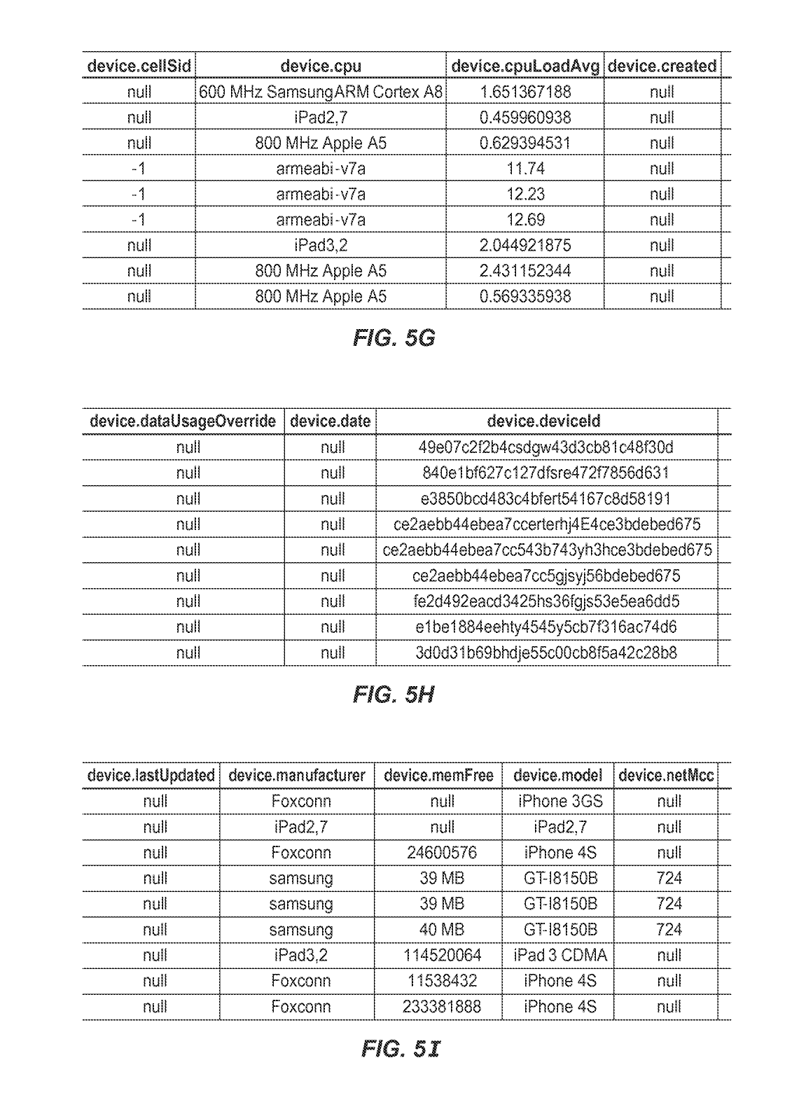

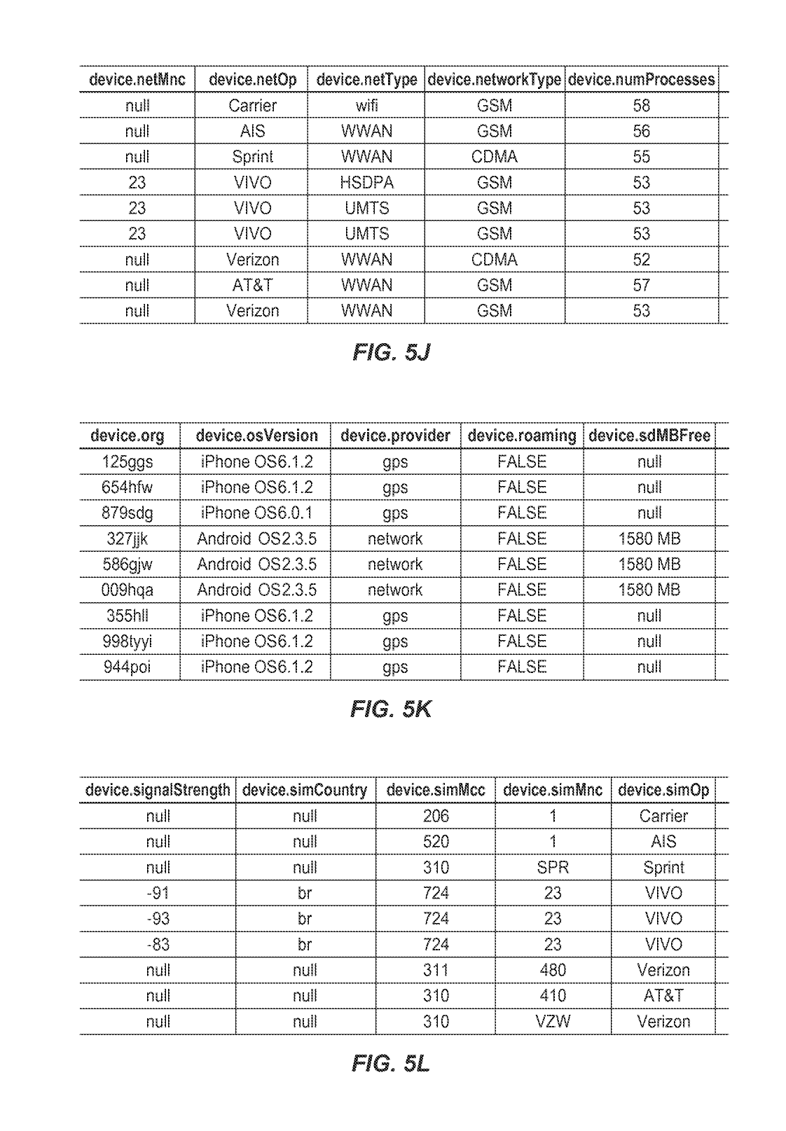

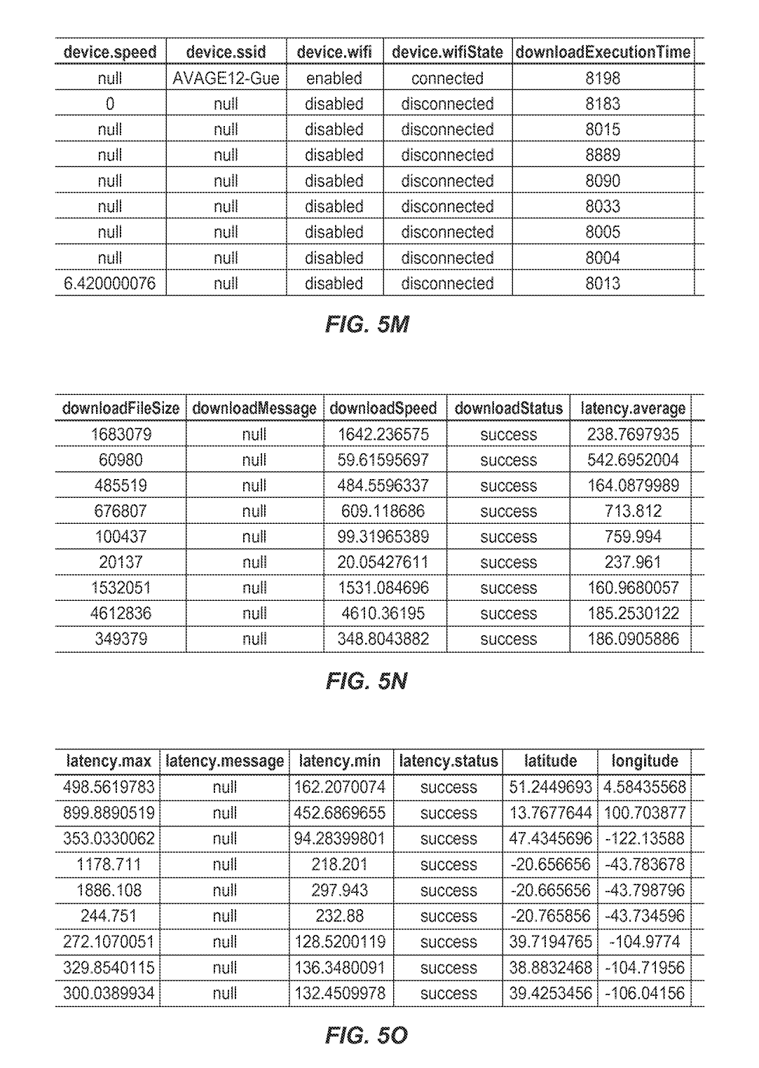

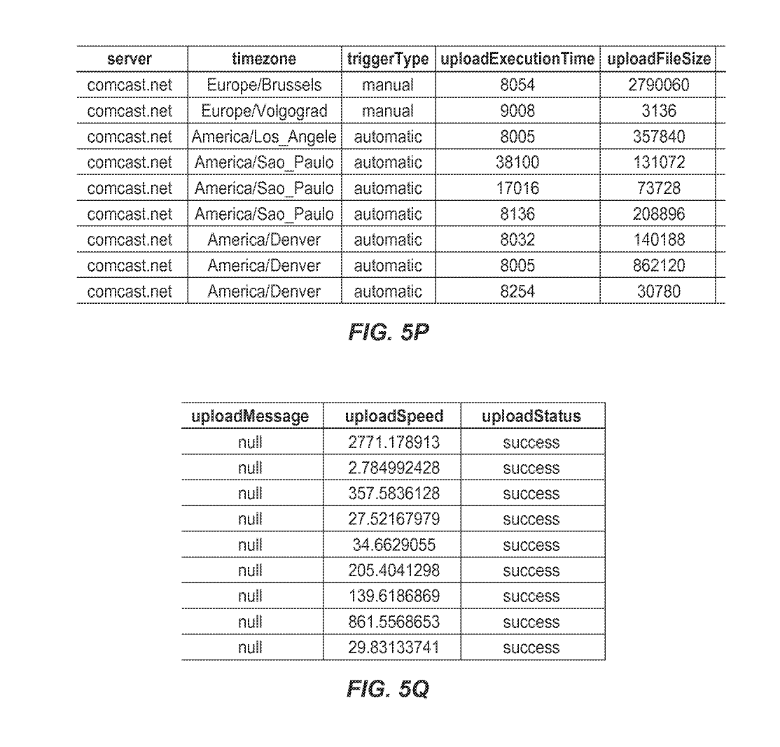

The Mobile Pulse System 100 enables the customer to administer the nature and frequency of the tests and data collection performed by their mobile devices 151-154. In particular, the customer can set parameters (most often a monthly data-use limit) at their mobile device that either (1) reduces the testing frequency, or (2) causes the system to run an alternative test where certain data points are not collected, e.g., download speed, in an effort to reduce data consumption. Other additional changes can be made at this administrator level that change the testing parameters of clients associated with that organization. In addition, the customer can set a temporal schedule of mobile device reporting to the Mobile Pulse WEB Site 101, to transfer the collected and generated data to database 104 in Mobile Pulse WEB Site 101. FIG. 4 illustrates a typical process that is used, and FIGS. 5A-5Q illustrate a simplified version of a typical data structure used in the Mobile Pulse System 100.

At step 401, the Mobile Pulse reporting application 151A self-activates pursuant to a timer function embedded therein, regardless of whether the mobile device 151 is presently in use. Optionally, the Mobile Pulse reporting application 151A also can activate in response to a handoff between cell sites/sectors or based on the customer requesting activation to collect data. At step 402, before a test is performed, the Mobile Pulse reporting application 151A must meet the configurable prerequisites to ensure that useful data is collected and that the mobile device 151 is capable of performing the tests without negatively impacting the operation of the mobile device 151. In particular, the typical prerequisites include a determination that the location being tested is unique in distance and time from the previous tested location in the wireless network and that the GPS accuracy, battery level, CPU load, and wireless network connection are physically capable of executing the test(s). Furthermore, the Mobile Pulse reporting application 151A must execute a test to ensure the quality of the connection. If prerequisites are met, the Mobile Pulse reporting application 151A at step 403 sends a test request over a secure communication connection to Mobile Pulse web server 141 via the cellular network 110A. At step 404, the Mobile Pulse web server 141 authenticates the user's mobile device 151, ensures that the Mobile Pulse reporting application 151A meets the minimum version requirement, that the mobile device 151 has not exceeded its allotted data transfer for the month, and approves the request to the Mobile Pulse reporting application 151A to perform a test. At step 405, the user's mobile device 151 and associated Mobile Pulse reporting application 151A execute the tests and measurements pursuant to the provisioned set of tests and measurements.

The data collected from a mobile device 151 as an example includes the well-known elements listed in FIGS. 5A-5Q. These include:

### 1. Signal Strength

In telecommunications, signal strength refers to the magnitude of the electric field at a reference point that is a significant distance from the transmitting antenna. It also may be referred to as received signal level or field strength. For very low-power systems, such as mobile phones, signal strength usually is expressed in dB-microvolts per meter (dBμV/m) or in decibels above a reference level of one milliwatt (dBm). Typically, this level is represented as a series of five bars with signal strength being reported as an integer between 1 and 5.

### 2. GPS Location

The Global Positioning System (GPS) is a space-based satellite navigation system that provides location and time information anywhere on or near the Earth, where there is an unobstructed line of sight to four or more GPS satellites. A GPS receiver calculates its position by precisely timing the signals sent by GPS satellites high above the Earth. Each satellite continually transmits messages that include the time the message was transmitted and satellite position at time of message transmission. The receiver uses the messages it receives to determine the transit time of each message and computes the distance to each satellite. These distances, along with the satellites' locations, are used to compute the position of the receiver in terms of latitude and longitude.

### 3. Bandwidth

The key characteristic of a wireless network is the ability to re-use frequencies to increase both coverage and capacity. Adjacent cells must use different frequencies (as shown in FIGS. 2A and 2B); however, there is no problem with two cells sufficiently far apart operating on the same frequency. The frequency reuse factor is the rate at which the same frequency can be used in the network. Where K is the number of cells in the frequency reuse pattern, then the total theoretical network bandwidth B available per cell site is B/K. In the case of N sector antennas on the same base station site with six shown (211A-211F to 214A-214F shown respectively in each of cells 211-214 of FIG. 2B), each aimed in a different direction and typically having alternating polarizations to minimize interference, the base station site can serve N different sectors and each sector can use a bandwidth of B/NK. The bandwidth available to each mobile device operating in a sector is, thus, a fraction of the total theoretical bandwidth B/NK, which is a function of the number of active users in the sector and their generated traffic. Thus, the bandwidth available for an active mobile device located in a sector dynamically varies as a function of the total traffic offered to the cell site.

### 4. Latency

Latency in a packet-switched network is measured either one-way (the time from the source sending a packet to the destination receiving it) or round-trip (the one-way latency from source to destination plus the one-way latency from the destination back to the source). Round-trip latency is more often quoted because it can be measured from a single point. Note that round-trip latency excludes the amount of time that a destination system spends processing the packet. Many software platforms provide a service called “ping” that can be used to measure round-trip latency. “Ping” performs no packet processing; it merely sends a response back when it receives a packet (i.e., performs a no-op); thus, it is a relatively accurate way of measuring latency. A typical packet is forwarded over many links via many gateways, each of which does not begin to forward the packet until it has been completely received. In such a network, the minimal latency is the sum of the minimum latency of each link, plus the transmission delay of each link except the final one, plus the forwarding latency of each gateway. In practice, this minimal latency is further augmented by queuing and processing delays. Queuing delay occurs when a gateway receives multiple packets from different sources heading towards the same destination. Since typically only one packet can be transmitted at a time, some of the packets must queue for transmission, incurring additional delay. Processing delays are incurred while a gateway determines what to do with a newly received packet.

At step 406, the Mobile Pulse reporting application 151A stores the data along with the time at which the data was collected in the memory of the mobile device 151. Periodically, the Mobile Pulse reporting application 151A of mobile device 151, at step 407, initiates a communication connection to Mobile Pulse WEB site 101 via the wireless network 110A. The Mobile Pulse reporting application 151A, once connected to Mobile Pulse WEB Site 101, transmits its unique identification information and customer identification information. The Mobile Pulse WEB site 101 activates authentication process 126, at step 408, to verify the identity of mobile device 151 and, once authenticated, authorizes Mobile Pulse reporting application 151A of mobile device 151 to upload the collected data, at step 409, to Mobile Pulse WEB site 101, which encrypts sensitive customer-specific data, such as passwords, and stores it in database 104 for future processing and reporting.

### Network Performance—Data Processing and Report Generation

The data collected by the Mobile Pulse WEB site 101 from the various Mobile Pulse reporting applications 151A-154A is stored in database 104 on a customer-centric basis. Each customer is assigned a segment of the database 104 for the storage of their encrypted data, which is inaccessible by other customers. In addition, the data for each customer is organized and managed as defined by the customer. A customer can arbitrarily define their organization map, as well as define the delegated administration of their data—different groups of administrators at different layers of the customer-defined hierarchy have the privileges to view certain data, and also are not able to access data beyond the scope of their permissions. Thus, the customer interface is self-adapting—it only shows the accessing administrator what the customer wants that administrator to see. The hierarchy is defined by the customer and can be parsed into multiple domains: department, job function, division of the organization, affiliates, etc.

### Poor Performance Metric

Customers are interested in receiving information which defines with greater clarity and precision the wireless service areas that, anecdotally, have poor service performance. In basic terms, the solution implemented by the Mobile Pulse System includes an algorithm applied to a customer's performance results in order to determine a percentage of tests within any given geography that have fallen below a given “poor performance” threshold.

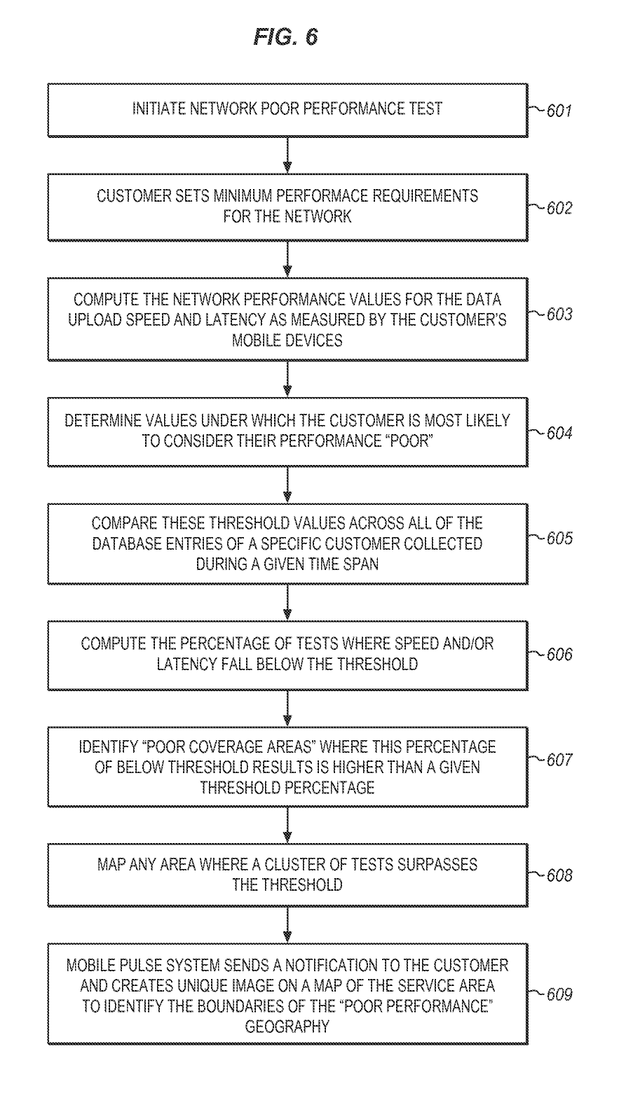

FIG. 6 illustrates, in flow diagram form, the operation of the Mobile Pulse System 100 to identify areas of wireless network poor performance. At step 601, the poor performance test is initiated for measuring the performance of the wireless network. Typically, there is a set of minimum network performance requirements that are used by the Mobile Pulse System 100 to compute a measure of the service provided to customers. The customer at step 602 optionally can adjust one or more of the minimum network performance requirements to customize their measure of network service.

At step 603, the Mobile Pulse System 100 computes the network performance values for the data upload speed (and/or data download speed) and latency as measured by the customer's mobile devices. These metrics are highly correlated with wireless network performance and, therefore, are suitable predictors of the service that will be provided to the customer's mobile devices when they are located in the service area. Based on the measured network performance values from step 603, the Mobile Pulse System 100 computes a value or set of values at step 604 which can be used as a measure under which the customer may consider their performance “poor”. The Mobile Pulse System 100 typically uses an algorithm to process the measured values of speed and latency, individually and/or in combination, to produce a composite value, such as by a general averaging process or other statistical process.

These computed threshold values then are compared at step 605 across all of the database entries collected during a given time span for a specific customer. The percentage of tests where speed and/or latency fall below a predetermined threshold is computed at step 606. Areas where this percentage of failed tests is above the predetermined threshold (say, “X” percent), then the geography is defined as a “poor coverage area” at step 607 These areas are not necessarily defined using a grid; rather, any area where a cluster of tests is below the “X” percent threshold is defined and mapped at step 608. The Mobile Pulse System then sends a notification to the customer at step 609 and creates a unique image on a map of the service area to identify the boundaries of the “poor performance” geography.

The computations can be based on a precise location of a cluster where the percentage of tests where speed and/or latency fall below a predetermined threshold, or a macro geographic view can be used to cover a larger physical area. Furthermore, a temporal view can be provided to illustrate a time varying view of the service area thereby to identify not only locations where performance is poor, but also the times of day when this performance problem is present at these locations. The collected data from a multitude of customers can be anonymized and used to provide a more statistically valid result, which also enables the Mobile Pulse System 100 to provide results on a per type of mobile device basis, so variations in performance caused by the selection of the mobile device or service provider can be viewed.

The execution of this database management can be implemented in many ways, and a typical directory used in the Mobile Pulse System 100 is illustrated in FIGS. 5A-5Q, where the data entries for a selected customer are shown in part.

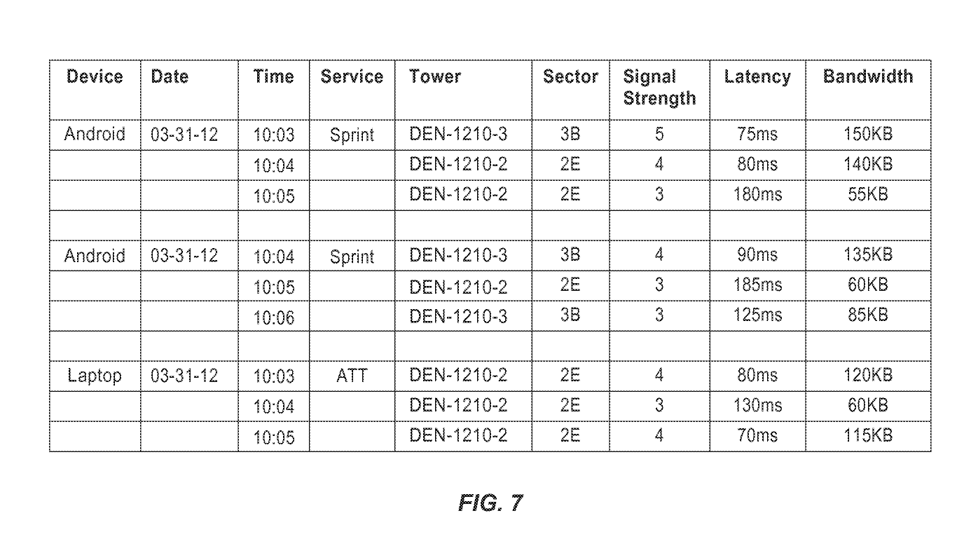

To illustrate the operation of the Mobile Pulse System 100 in a cellular network using a simple example, three mobile devices were characterized: two Android phones and a Windows-based laptop. These are identified by a unique identifier and three sequential data entries that are created in database 104 for each mobile device shown in FIG. 7. The date and time for each set of measurements are listed, as is the service provider and the tower identification in this example. The tower identification is listed as DEN for Denver, 1210 for a particular district of the Denver call coverage area, and the last digit represents the cell in this district, as shown on FIGS. 2A and 2B. In addition, the particular sector of each cell which serves this set of tests and measurements also is listed (also shown in FIG. 2B). For simplicity of description, only the signal strength, latency, and bandwidth are shown. As can be seen from these data entries, tower DEN-1210-2, sector 2E, has consistently poor performance for the Android phones and slightly better performance for the Windows-based laptop. As the first listed Android phone roams from cell 3, sector 3B, to the adjacent cell 2, sector 2E, performance drops significantly. This effect also is consistent with the second listed Android phone at the same time and the same cells and sectors. Thus, the collected data enables the tracking of problem sites in the wireless network as well as types of mobile devices which receive better performance than others in certain sections of the network. The analysis function 123 can use the collected data, both temporal and spatial in nature, to identify anomalies in the wireless network performance or failure of the service provider to supply the level of service as guaranteed in the service agreement—such as bandwidth, latency, etc.

The data illustrated in FIGS. 5A-5Q and FIG. 7 is tabular in nature but can be rendered into a multi-dimensional graphical representation by mapping function 121 or outsourced to Map Rendering Service 103, which can be a contract service external to Mobile Pulse WEB site 101, or can be a separate licensed functionality located within Mobile Pulse WEB site 101. In addition, the Report Generator 115 can process the collected data into a report format selected by the customer for access/delivery via the WEB Portal 109 which can be on an automated basis triggered by the notification process 124 and which would typically be encrypted by encryption process 125 for the security of the customer's data. The analysis function 123 is equipped with a plurality of filters which enable the customer to parse data by date/time, geographic location, wireless service provider, device type, or other metric selected by the customer. It also is possible to anonymize the data that has been collected—removing the customer-specific data and integrating data from multiple customers to produce an overall network performance snapshot. Thus, the tabular data of FIGS. 5A-5Q can be viewed as merely one “layer” of a multi-layer matrix of customer-collected data, which provides the Mobile Pulse System 100 with the capability in analysis function 123 to “slice” in various directions through the matrix of data to obtain various views of the dynamic response of the wireless network to traffic loads and movement of mobile devices among the sectors and cells. In addition, various statistical methods can be employed to both interpret the received data and to interpolate/extrapolate the data to attain more accurate estimations of wireless network performance. For example, geocoding processes 122 can be used to interpolate the value of a random field (e.g., the signal strength as a function of the geographic location) at an unobserved location from observations of its value at nearby locations. Such processes benefit from the volume of data collected and the anonymization of the data which enables the Mobile Pulse system to provide useful wireless network performance data.

### Summary

The Mobile Pulse System makes use of a client application which is installed in each mobile device of a customer to obtain dynamic measurements of the service that is provided to the mobile device by a wireless service provider. These client applications perform frequent tests to determine the level of service that they are presently receiving, which test results are transmitted to the Mobile Pulse System server for compilation and analysis.

What is claimed:

1. A wireless network management system for dynamically determining a level of service provided by a wireless network to mobile devices operational in the service area of the wireless network comprising:
a service application, operational on each of a plurality of mobile devices that are operational in a service area of the wireless network, for performing measurements of various wireless network characteristics as presented at the mobile device, comprising:
a wireless network characteristic measurement for measuring at least one characteristic of the wireless network as presented at the mobile device,
data storage for storing the measured at least one characteristic of the wireless network as presented at the mobile device,
a data transmitter for transmitting the stored at least one measured characteristic of the wireless network as presented at the mobile device to a predetermined server; and
a network analysis processor for processing the stored at least one measured characteristic of the wireless network received from the plurality of mobile devices to determine a level of service provided to the plurality of mobile devices by the wireless network.

2. The wireless network management system of claim 1 wherein the service application further comprises:
a test customization controller for enabling a customer at the associated mobile device to select at least one of a plurality of tests and thresholds to measure selected characteristics of the wireless network as presented at the mobile device.

3. The wireless network management system of claim 1, further comprising:
a report generator, responsive to receipt of measured characteristic data received from a plurality of mobile devices of a selected customer, for processing the received stored at least one measured characteristic of the wireless network into a report illustrative of a level of service provided by the wireless network to the customer mobile devices.

4. The wireless network management system of claim 2, further comprising:
a map generator, responsive to receipt of measured characteristic data received from a plurality of mobile devices of a selected customer, for processing the received stored at least one measured characteristic of the wireless network into a map illustrative of a level of service provided by the wireless network to the customer mobile devices.

5. The wireless network management system of claim 1 wherein the service application further comprises:
test activation for enabling the wireless network characteristic measurement based on at least one of the test activation paradigms including: periodic, change of cell site/WiFi access portal, threshold of measured wireless network performance metrics, determination that the location being tested is unique in distance and time from the previous tested location in the wireless network, and that the GPS accuracy, battery level, CPU load, and wireless network connection are physically capable of executing the test(s).

6. The wireless network management system of claim 1 further comprising:
a security process for identifying and authenticating a mobile device that is in communication with the predetermined server.

7. The wireless network management system of claim 1 wherein the network analysis processor comprises:
a customer-specific performance analysis for processing the stored at least one measured characteristic of the wireless network received from the plurality of mobile devices to determine a level of service provided by the wireless network to at least one of the customer's mobile devices.

8. The wireless network management system of claim 1 wherein the network analysis processor comprises:
a customer database, responsive to receipt of measured characteristic data received from a plurality of mobile devices of a selected customer, for storing the received stored at least one measured characteristic of the wireless network in a memory location associated with the customer's account.

9. The wireless network management system of claim 1 further comprising:
processing the received data using statistical methods to interpolate/extrapolate the data to attain more accurate estimations of wireless network performance.

10. The wireless network management system of claim 1 wherein the network analysis processor comprises:
at least one threshold which is indicative of a level of wireless network service that is unacceptable; and
a statistical processor for processing the stored at least one measured characteristic of the wireless network received from the plurality of mobile devices to determine a percentage of instances of the measured characteristics falling below the at least one threshold.

11. The wireless network management system of claim 10 wherein the network analysis processor further comprises:
a poor level of service indicator for generating an indication that the percentage of instances of the measured characteristics for an identified site and time has fallen below the at least one threshold.

12. A wireless network management system for dynamically determining a level of service provided by a wireless network to mobile devices operational in the service area of the wireless network comprising:
a customer account manager for maintaining a customer account for each of a plurality of customers of the wireless network management system whose mobile devices are operational in the service area of the wireless network;
a service application, operational on each of a plurality of customers' mobile devices that are operational in a service area of the wireless network, for performing measurements of various wireless network characteristics as presented at the mobile device, comprising:
a wireless network characteristic measurement for measuring at least one characteristic of the wireless network as presented at the mobile device,
data storage for storing the measured at least one characteristic of the wireless network as presented at the mobile device,
a data transmitter for transmitting the stored at least one measured characteristic of the wireless network as presented at the mobile device to a predetermined server;
a network customer database, responsive to receipt of measured characteristic data received from a plurality of mobile devices of a selected customer, for storing the received stored at least one measured characteristic of the wireless network in a memory location associated with the customer's account;
a data anonymizer responsive to receipt of measured characteristic data received from a plurality of mobile devices of a selected customer for anonymizing the received data; and
a network analysis processor for processing the anonymized data of a plurality of customers to determine a level of service provided to mobile devices by the wireless network.

13. The wireless network management system of claim 12 wherein the service application further comprises:
a test customization controller for enabling a customer at the associated mobile device to select at least one of a plurality of tests and thresholds to measure selected characteristics of the wireless network as presented at the mobile device; and
a report generator, responsive to receipt of measured characteristic data received from a plurality of mobile devices of a selected customer, for processing the received stored measured selected characteristics of the wireless network into a report illustrative of a level of service for the selected characteristics provided by the wireless network to at least one of the customer's mobile devices.

14. The wireless network management system of claim 12 wherein the network analysis processor comprises:
a network map generator, responsive to receipt of the anonymized data of a plurality of customers, for producing a map illustrative of a level of service provided by the wireless network.

15. The wireless network management system of claim 12 further comprising:
a wireless network performance analysis for processing the anonymized data of a plurality of customers to determine a level of service provided to mobile devices by the wireless network.

16. The wireless network management system of claim 15 wherein the wireless network performance analysis processes the received data using statistical methods to interpolate/extrapolate the data to attain more accurate estimations of wireless network performance.

17. The wireless network management system of claim 12 wherein the service application further comprises:
test activation for enabling the wireless network characteristic measurement based on at least one of the test activation paradigms including: periodic, change of cell site/WiFi access portal, threshold of measured wireless network performance metrics, determination that the location being tested is unique in distance and time from the previous tested location in the wireless network, and that the GPS accuracy, battery level, CPU load, and wireless network connection are physically capable of executing the test(s).

18. The wireless network management system of claim 17 wherein the service application further comprises:
a test customization controller for enabling a customer at the associated mobile device to select tests to measure selected characteristics of the wireless network as presented at the mobile device.

19. The wireless network management system of claim 17 wherein the service application further comprises:
a test customization controller for enabling a customer at the associated mobile device to select at least one activation paradigm to measure selected characteristics of the wireless network as presented at the mobile device.

20. The wireless network management system of claim 12 wherein the network analysis processor comprises:
at least one threshold which is indicative of a level of wireless network service that is unacceptable; and
a statistical processor for processing the stored at least one measured characteristic of the wireless network received from the plurality of mobile devices to determine a percentage of instances of the measured characteristics falling below the at least one threshold.

21. The wireless network management system of claim 20 wherein the network analysis processor further comprises:
a poor level of service indicator for generating an indication that the percentage of instances of the measured characteristics for an identified site and time has fallen below the at least one threshold.
